(19) United States
(12) Patent Application Publication
(10) Pub. No.: US 2009/0151256 A1
(43) Pub. Date: Jun. 18, 2009

(54) BASEMENT DOOR OPENER

(76) Inventor: Lawrence J. Koncelik, JR., East Hampton, NY (US)

Correspondence Address: Mr. Walter J. Tencza Jr., Suite 210, 100 Menlo Park, Edison, NJ, 08837, US

(21) Appl. No.: 12/390,797

(22) Filed: Feb. 23, 2009

Related U.S. Application Data
(63) Continuation-in-part of application No. 11/255,443, filed on Oct. 21, 2005.

(51) Int. Cl. E05F 15/20; E06B 3/00; G08B 21/00; G05B 23/02

(52) U.S. Cl. 49/31; 49/506; 340/686.1; 340/3.1

(57) ABSTRACT

A device is provided for opening and closing a basement door leaf. The device may include a motor and a piston for pushing the door leaf open and pulling the door leaf closed in response to activation by an input device. A sensor device is provided for detecting a person's foot on a stair leading to a basement. The sensor device may cause the opening of the basement door leaf.

### CROSS-REFERENCE TO RELATED APPLICATION(S)

The present application is a continuation in part of and claims the priority of U.S. patent application Ser. No. 11/255,443, titled “BASEMENT DOOR OPENER”, filed on Oct. 21, 2005.

### FIELD OF THE INVENTION

This invention relates to improved methods and apparatus concerning opening basement doors.

### BACKGROUND OF THE INVENTION

Typically in the prior art basement doors are opened by hand. When entering from outside the basement one must typically bend over and lift open a door leaf sufficiently far so that a safety latch engages so that the door leaf does not fall back shut. An individual would then proceed down a basement stairway a few steps and then, turn around while still on the stairway to unlatch the safety latch previously set. The individual would then manually close the door behind himself or herself as the individual goes down the basement stairway backwards.

When exiting from a basement through a horizontal doorway an individual typically must proceed a few steps up a usually poorly lit stairway. Then individual would then open the safety latch and push a door leaf open will walking up the stairs at the same time. The individual would then proceed all the way up the stairway while pushing the door leaf until the door leaf finally swings far enough open so that the safety latch catches. The individual would typically then bend over to close the door behind himself or herself.

The procedure described above is clumsy, strenuous and even dangerous. Many older and infirm individuals are not even able to use their basement entryways because of the problems described above.

Various counterbalancing devices, such as gas springs, are known for making it easier or safer to open or close a basement door by hand. One such device, shown in U.S. Pat. No. 6,799,395, to Dabrowski “decelerates the movement of a door leaf during opening of the door and firmly supports the door without the need of an additional hold-open device and allows the user to close the door leaf with one hand rather than two”. (Dabrowski, col. 2, lns. 2-6). However, such devices still require an operator to open a door leaf by hand and they do not provide for a means to close the door other than by hand.

### SUMMARY OF THE INVENTION

In one embodiment of the present invention, an apparatus is provided comprising a basement door leaf opening and closing device, and an input device which can activate the basement door leaf opening and closing device. The input device can be set by an operator the cause the basement door leaf opening and closing device to push a basement door leaf into an open position or pull a basement door leaf into a closed position.

The input device may include a keypad having one or more keys. The one or more keys on the keypad when activated may cause the basement door leaf opening and closing device to push the basement door leaf into an open position. The one or more keys on the keypad when activated may cause the basement door leaf opening and closing device to pull the basement door leaf into a closed position. The keypad may be adapted to be mounted outside of a basement or inside of a basement.

The basement door leaf opening and closing device may include an electric motor, which is adapted to be rotatably mounted to a base, and a piston having first and second ends, wherein the first end is connected to the electric motor and the second end is adapted to be rotatably mounted to a basement door leaf.

The basement door leaf opening and closing device may alternatively include an electric motor, which is adapted to be fixedly mounted to a structural member, such as a reinforced top wall portion of a basement door device.

At least one embodiment of the present invention includes an apparatus comprising a basement door leaf opening and closing device, and a first sensor device. The first sensor device may be configured so that it can be mounted in relation to a first stair leading to a basement so that a person stepping on the first stair with their foot will cause activation of the first sensor device. Activation of the first sensor device may cause the basement door leaf opening and closing device to open a basement door leaf. The apparatus may include the first stair itself. The first sensor device may be an optical sensor device or a pressure sensitive mat device.

In at least one embodiment of the present invention, the apparatus may include a second sensor device, configured so that it can be mounted in relation to a second stair leading to the basement so that a person stepping on the second stair with their foot will cause activation of the second sensor device. Activation of the second sensor device may causes the basement door leaf opening and closing device to open the basement door leaf. The first stair and the second stair may be the same, i.e. the first sensor device and the second sensor device may be both configured to detect a person stepping on the same stair. Alternatively, the first and the second stair may be different, i.e. the first sensor device may detect a person stepping on one stair, and the second sensor device may detect a person stepping on a different stair.

In at least one embodiment the apparatus may include a computer processor. The first sensor device may communicate with the computer processor and activation of the first sensor device may send a signal to the computer processor which causes the computer processor to send a signal to the basement door leaf opening and closing device to open the basement door leaf.

A method is also provided, in accordance with an embodiment of the present invention, and may include installing a basement door leaf opening and closing device so that the basement door leaf opening and closing device can open and close a basement door leaf leading to a basement. The method may further include installing a first sensor device in relation to a first stair leading to the basement so that a person stepping on the first stair with their foot will cause activation of the first sensor device. The method may also include configuring the first sensor device with respect to the basement door leaf opening and closing device so that the activation of the first sensor device causes the basement door leaf opening and closing device to open the basement door leaf.

### BRIEF DESCRIPTION OF THE DRAWINGS

FIG. 1 shows a perspective view of an apparatus in accordance with an embodiment of the present invention;

FIG. 2 shows a perspective view of an apparatus in accordance with another embodiment of the present invention;

FIG. 3A shows a perspective view of an apparatus in accordance with another embodiment of the present invention;

FIG. 3B shows a side view of some of the components of the apparatus of FIG. 3A, with the apparatus of FIG. 3A in a first state in which a basement door is closed;

FIG. 3C shows a side view of some of the components of the apparatus of FIG. 3A, with the apparatus of FIG. 3A in a second state in which a basement door is opened;

FIG. 4 shows a perspective view of a pin which can be used for various pins in FIGS. 1-3C;

FIG. 5 shows a perspective front view of an apparatus including a plurality of stairs and a plurality of stair mat sensors in accordance with another embodiment of the present invention;

FIG. 6 shows a block diagram of an apparatus including the plurality of stair mat sensors, a computer processor, a computer memory, an interactive device, a computer monitor, and a door opener motor in accordance with another embodiment of the present invention;

FIG. 7 show a perspective front view of an apparatus including a plurality of stairs and a plurality of optical devices in accordance with another embodiment of the present invention; and

FIG. 8 shows a block diagram of an apparatus including a plurality of optical sensors, a computer processor, a computer memory, an interactive device, a computer monitor, and a door opener motor in accordance with another embodiment of the present invention.

### DETAILED DESCRIPTION OF THE DRAWINGS

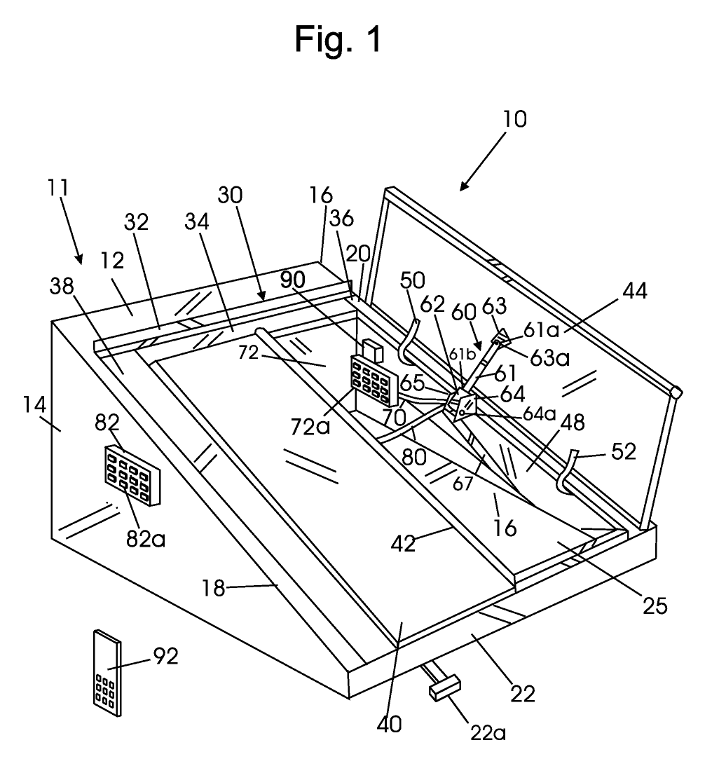

FIG. 1 shows a perspective view of an apparatus 10 in accordance with an embodiment of the present invention. The apparatus 10 is comprised of foundation or base 11, door device 30, door leaf opening and closing device 60, and various other components, which will be described.

The foundation or base 11 includes sidewalls 14 and 16, top wall portions 12, 18, and 20, and front wall 22. The top wall portions 12, 18, 20, and front wall 22 surround an opening 25 over which the door device 30 is placed.

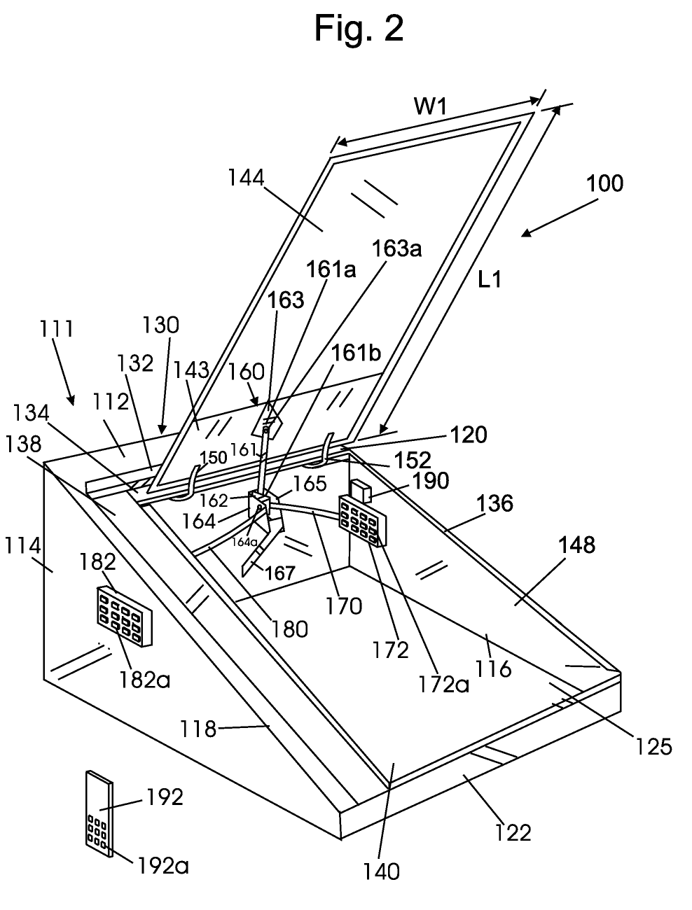

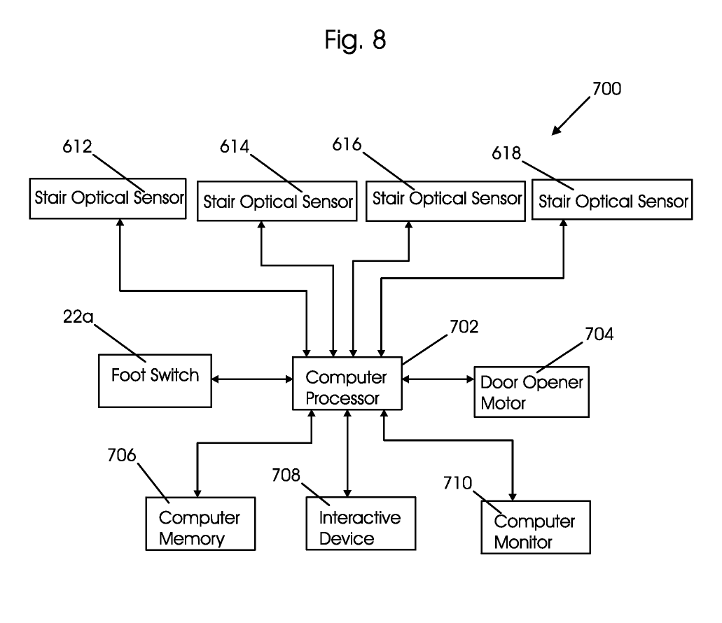

The door device 30 includes an upwardly extending header flange 32, a flat plate header 34, an elongated flat plate 36, a flat plate 38, a left door leaf 40, a right door leaf 44, and a plate 48. The door device 30 may be similar to that shown in FIG. 2 or FIG. 8 of U.S. Pat. No. 6,799,395, which is fully incorporated herein by reference. The door device 30 may include hinges 50 and 52 which connect the right door leaf 44 to the flat plate 36, top wall portion 20, and/or the side wall 16, in a manner which allows the right door leaf 44 to rotate into an opened or closed position. In the closed position the right door leaf 44 and the left door leaf 40 completely cover the opening 25 in the base or foundation 11 so that water cannot get through the opening 25 in the foundation or base 11.

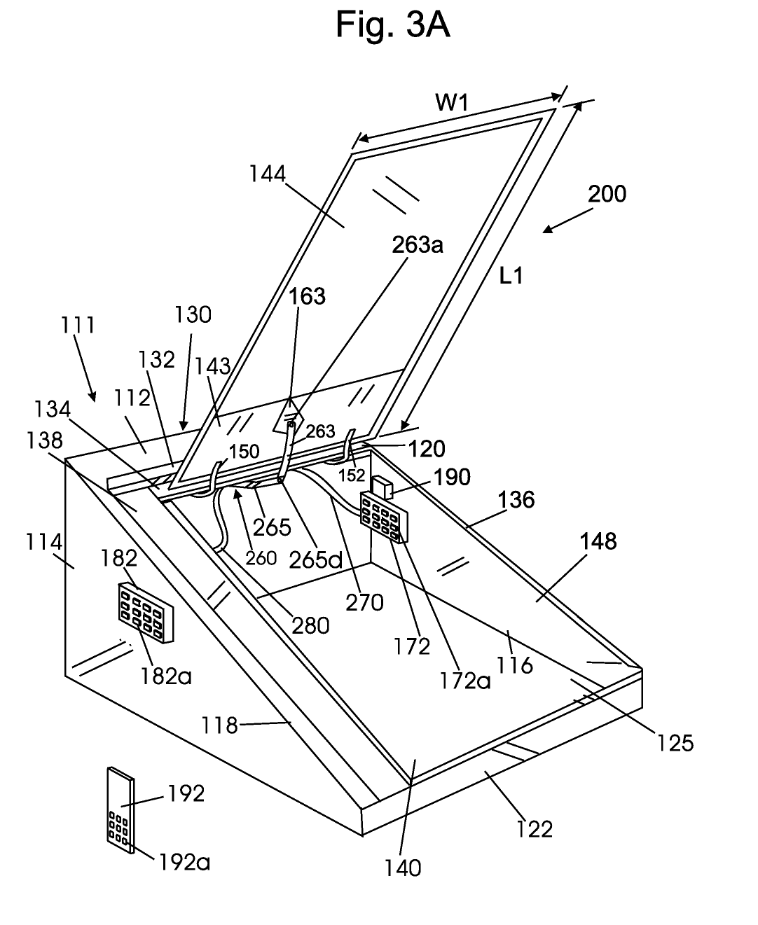

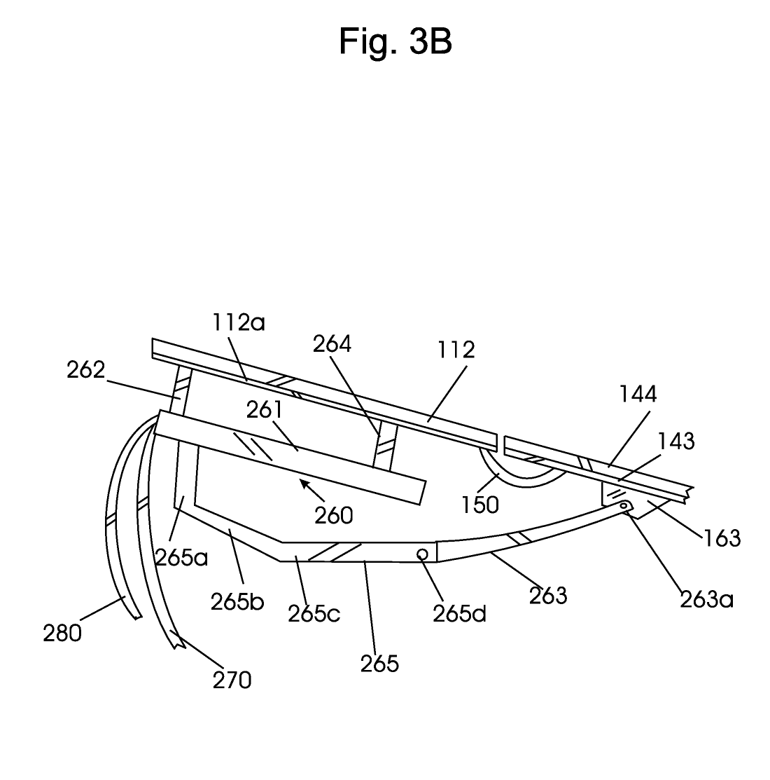

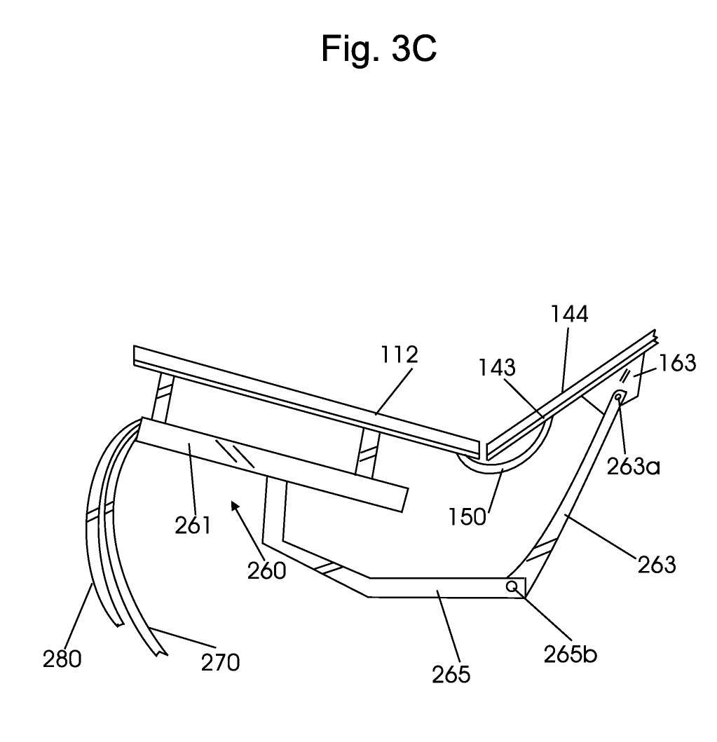

The door leaf opening and closing device 60 includes an electric motor 62 connected to a piston, rod or cylinder 61. The piston 61 may be an electric and/or hydraulic piston, an electric screw, or an electric screwworm jack. The piston 61 is typically connected to the motor 62 so that the piston 61 can slide with respect to the motor 62 but cannot rotate with respect to the motor 62. The motor 62 is rotatably mounted to brackets 64 and 65, through a pivot pin 64a, so that the motor 62 can rotate about pivot pin 64a with respect to the brackets 64 and 65. The piston 61 has an end 61a, which is rotatably mounted to a bracket 63 through a pivot pin 63a, so that the piston 61 can rotate about pivot pin 63a with respect to the bracket 63. The piston 61 has an end 61b, which is connected to the motor 62. The brackets 64 and 65 are fixed to the side wall 16. The bracket 63 is fixed to the right door leaf 44. The brackets 64 and 65 are also fixed to an elongated brace 67 shown in FIG. 1. The brace 67 may be similar to the brace 27 shown in FIG. 3A of U.S. Pat. No. 6,799,395 to Dabrowski et. al., which is incorporated herein by reference.

The motor 62 is electrically connected through a conductor or cord 70 to a keypad device 72. The keypad device 72 has keys or buttons 72a. One or more of the keys or buttons 72a can be pressed to cause the electric motor 62 to push or extend piston 61 and thereby push the right door leaf 44 into the fully open position shown in FIG. 1. One or more of the keys or buttons 72a can be pressed to cause the electric motor 62 to pull or retract piston 61 and thereby pull the right door leaf 44 into a fully closed position (not shown) where opening 25 is completely covered.

The motor 62 is also electrically connected through a conductor or cord 80 to a keypad device 82. The keypad device 82 is mounted to the exterior of side wall 14. The keypad device 82 has keys or buttons 82a. One or more of the keys or buttons 82a can be pressed to cause the electric motor 62 to push or extend piston 61 and thereby push the right door leaf 44 into the fully open position shown in FIG. 1. One or more of the keys or buttons 82a can be pressed to cause the electric motor 62 to pull or retract piston 61 and thereby pull the right door leaf 44 into a fully closed position (not shown) where opening 25 is completely covered.

The apparatus 10 includes a receiver 90 and a transmitter or remote control device 92. The remote control device 92 may have a plurality of keys or buttons 92a, which can be pressed or activated to cause a remote control signal to be sent to the receiver 90. The receiver 90 may be electrically connected to the motor 62, such as through the cord 70 or through the keypad 72 and the cord 70. The remote control device 92 may be similar to a remote control garage door opener. The remote control device 92 may send out any type of remote control, typically wireless, signal. The receiver 90 receives the remote control signal from device 92 and causes the motor 62 to be activated to either push open the door leaf 44 using piston 61 or pull close the door leaf 44 using piston 61.

FIG. 2 shows a perspective view of an apparatus 100 in accordance with another embodiment of the present invention. The apparatus 100 may include is comprised of foundation or base 111, door device 130, door opening and closing device 160, and various other components, which will be described.

The foundation or base 111 may be similar to or identical to the base 11 shown in FIG. 1. The base 111 includes sidewalls 114 and 116, top wall portions 112, 118, and 120, and front wall 122. The top wall portions 112, 118, 120, and front wall 122 surround an opening 125 over which the door device 130 is placed. The top wall portion 112 may be reinforced or provided with an extra plating.

The door device 130 includes an upwardly extending header flange 132, a flat plate header 134, an elongated flat plate 136, a flat plate 138, a door 144, and a plate 148. The late plate header 134 may be reinforced with an extra layer of plating or steel for strength. The door device 30 may include hinges 150 and 152 which connect the door 144 to the flat plate 134, top wall portion 112, in a manner which allows the door 144 to rotate into an opened or closed position. In the closed position the door 144 completely covers the opening 125 in the base or foundation 111 so that water cannot get through the opening 125 in the foundation or base 111. The door 144 is comprised of a single door leave having a width W1 and a length L1. The Length L1 is typically substantially greater than the width W1. For example the length L1 may be two times greater than the width W1.

The door or door leaf opening and closing device 160 includes an electric motor 162 connected to a piston 161. The piston 161 may be an electric and/or hydraulic piston, an electric screw, or an electric screwworm jack. The piston 161 is capable of extending or expanding to the fully extended or expanded position shown in FIG. 2 or compressing, retracting or telescoping inward to a fully retracted position (not shown) in which the door 144 is closed over the opening 125. The motor 162 is rotatably mounted to brackets 164 and 165, through a pivot pin 164a, so that the motor 162 can rotate about pivot pin 164a with respect to the brackets 164 and 165. The piston 161 has an end 161a, which is rotatably mounted to a bracket 163 through a pivot pin 163a, so that the piston 161 can rotate about pivot pin 163a with respect to the bracket 163. The piston 161 has an end 161b, which is connected to the motor 162. The brackets 164 and 165 are fixed to the top wall portion 112. The bracket 163 is fixed to the door 144. The bracket 163 may be fixed to the door 144 through a plate or reinforcing bar 143, which provides extra strength. The reinforcing bar or plate 143 may run the along an entire bottom section of the door 144, i.e. the door 144 may be “doubled up” or reinforced along the area of plate 143. The top wall portion 112 may also be reinforced or “doubled up” by a reinforcing bar or section 112a. The reinforcing through 143 and 112a is done to help bear the stresses involved in lifting the door 144. The brackets 64 and 65 are also fixed to an elongated brace 167 shown in FIG. 2. The brace 167 may be similar to the brace 27 shown in FIG. 3A of U.S. Pat. No. 6,799,395 to Dabrowski et. al., which is incorporated herein by reference.

The motor 162 is electrically connected through a conductor or cord 170 to a keypad device 172. The keypad device 172 has keys or buttons 172a. One or more of the keys or buttons 172a can be pressed to cause the electric motor 162 to push or extend the piston 161 and thereby push the door 144 into the fully open position shown in FIG. 2. One or more of the keys or buttons 172a can be pressed to cause the electric motor 162 to pull or retract piston 161 and thereby pull the door 144 into a fully closed position (not shown) where the opening 125 is completely covered.

The motor 162 is also electrically connected through a conductor or cord 180 to a keypad device 182. The keypad device 182 is mounted to the exterior of sidewall 114. The keypad device 182 has keys or buttons 182a. One or more of the keys or buttons 182a can be pressed to cause the electric motor 162 to push or extend piston 61 and thereby push the door 144 into the fully open position shown in FIG. 1. One or more of the keys or buttons 182a can be pressed to cause the electric motor 62 to pull or retract piston 61 and thereby pull the door 144 into a fully closed position (not shown) where opening 25 is completely covered.

The apparatus 110 includes a receiver 190 and a transmitter or remote control device 192. The remote control device 192 may have a plurality of keys or buttons 192a, which can be pressed or activated to cause a remote control signal to be sent to the receiver 190. The receiver 190 may be electrically connected to the motor 162, such as through the cord 170 or through the keypad 172 and the cord 170. The remote control device 192 may be similar to a remote control garage door opener. The remote control device 192 may send out any type of remote control, typically wireless, signal. The receiver 190 receives the remote control signal from device 192 and causes the motor 162 to be activated to either push open the door 144 using piston 161 or pull close the door 144 using the piston 161.

FIG. 3A shows a perspective view of an apparatus 200 in accordance with another embodiment of the present invention. FIG. 3B shows a side view of some of the components of the apparatus 200 of FIG. 3A, with the apparatus 200 of FIG. 3A in a first state in which a basement door or single door leaf 144 is closed. FIG. 3C shows a side view of some of the components of the apparatus 200 of FIG. 3A, with the apparatus 200 of FIG. 3A in a second state in which a basement door is opened.

The apparatus 200 includes components, which have previously been described with reference to FIG. 2. However, the door opening and closing device 160 has been replaced by a door opening and closing device 260, parts of which are shown in FIG. 3A and parts of which are shown in FIGS. 3B and 3C. The door opening and closing device 260 includes a motor 261 (which may include an internal clutch/torque limiter), shown in FIGS. 3B and 3C, which may be similar to the motor used for the driving unit 105 in U.S. Pat. No. 6,283,535, to Yuge, which is incorporated herein by reference. The door opening and closing device 260 also includes brackets 262 and 264, which fixedly mount the motor 261 to the reinforced top wall portion 112. The motor 261 may also be fixedly mounted to a structural beam a structural beam of a building or a beam located inside of the basement door 144. The motor 261 may be mounted to a beam that is horizontal with respect to ground but at an angle with respect to the top wall portion 112. The motor 261 may be otherwise horizontally mounted with respect to ground. This allows the door 144 to be open wider with less sliding movement of a member 265.

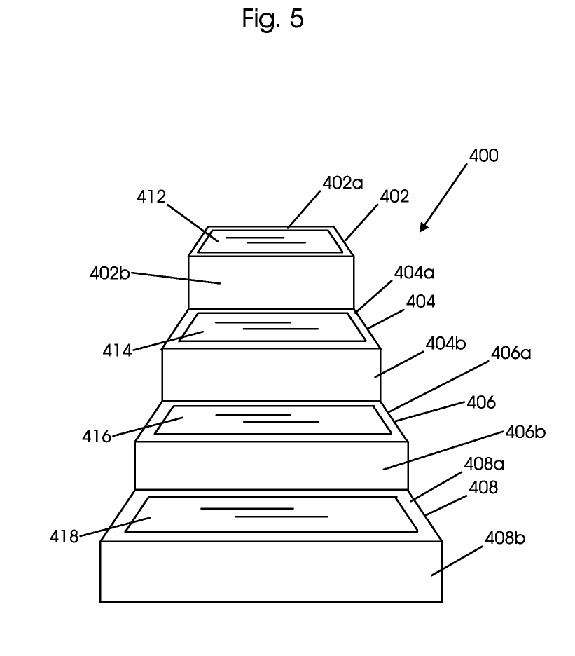

The motor 261 is electrically connected to keypads 172 and 182 by bus, cord, or communication lines 270 and 280 respectively. Only parts of cords 270 and 280 are shown in FIGS. 3A, 3B, and 3C for simplification. The keypads 172 or 182 can be used to operate the motor 261 to lift open or shut the door 144. The motor 261 is mechanically connected to member 265, which is pivotally connected by pivot pin 265d to member 263. The member 263 is pivotally connected to bracket 263 through pivot pin 263a. The member 265 is comprised of downwardly extending portion 265a, diagonal portion 265b, and horizontal portion 265c. The opening and closing device 260 may be similar to that shown in FIG. 5, 9, or 10 of U.S. Pat. No. 6,283,535, which is incorporated herein by reference.

In operation, an individual would press one or more keys 172a or 182a on keypads 172 or 182, respectively, to cause the motor 261 to open or close the door 144. To transition from the closed door state of FIG. 3B to the open door state of FIG. 3C, the motor 261 causes the member 265 to slide to the right. The member 265 which sliding to the right, pushes on the member 263, which pushes on the bracket 163, which pushes on the door 144, causing the door 144 to open. As the member 265 slides to the right, the member 263 pivots upwards about pivot point 265d and the door 144 pivots upwards about hinge 150. To transition back to the closed state of FIG. 3B from the open state of FIG. 3C, the member 265 slides to the left, and thereby pulls the member 263. The member 263 pivots downward about pivot point 265d, causing the door 144 to pivot downward about hinge 150.

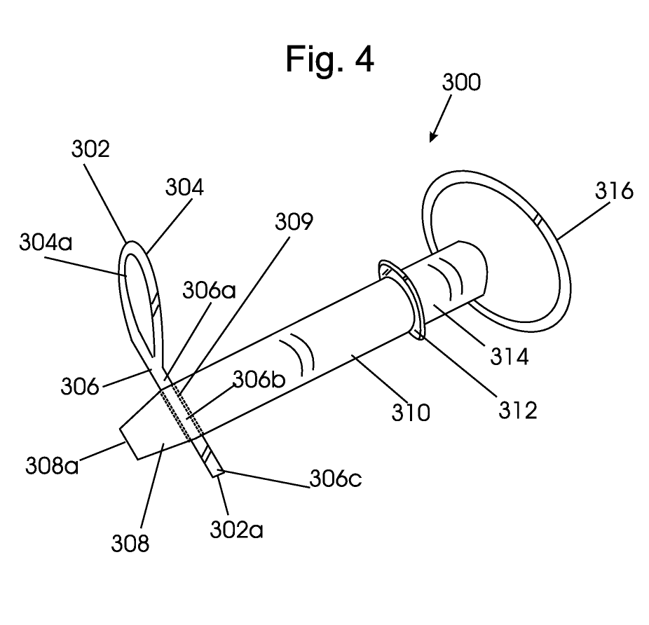

Each of pivot pins 63a, 64a, 163a, 164a, 263a, and 265d may be pivot pin in the nature of a clevis hitch pin so that each of pivot pins 63a, 64a, 163a, 164a, 263a, and 265d can be removed by hand and without the use of a tool, to disconnect the appropriate door opening and closing device from the appropriate door, the appropriate motor and/or the appropriate arm. This will allow an individual to open or close the door manually and without being constrained by the appropriate door opening and closing device. FIG. 4 shows a perspective view of a pin 300, which may be a clevis pin, and which can be used for various pins in FIGS. 1-3C, such as for any one of pivot pins 63a, 64a, 163a, 164a, 263a, and 265d.

Pin 300 includes retaining pin 302, narrowed portion 308, cylinder 310, ridge 312, cylinder 314, and ring 316. The retaining pin 302 includes a ring portion 304 integrated with a straight portion 306. The straight portion 306 includes sections 306a, 306b, and 306c. The section 306b is shown in dashed lines and is located inside of a hole 309, which is also shown by dashed lines. The hole 309 is located inside of the cylinder 310. The pin 300 can be placed so that the cylinder 310 is the pivot or axle for rotation. For example, if the pin 300 is used for the pivot pin 63a, the retaining pin 302 would be pulled out of the opening 309 and then an end 308a would be inserted into a opening, not shown, in the bracket 63 and an opening, not shown, in the piston 61, so that the piston 61 is rotatably or pivotally mounted with respect to the bracket 63. After insertion, an end 302a of the retaining pin 302 would be inserted into the opening 309 so that the retaining pin 302 would be located as in FIG. 4, to prevent the cylinder 310 from being detached from the bracket 63 and the piston 61. When the pin 300 pivotally connects the bracket 63 to the piston 61, a portion of the bracket 63 and a portion of the piston 61 would lie between the ridge 312 and the pin 302. The ridge 312 and the pin 302 prevent the bracket 63 and the piston 61 from coming apart while the piston 61 is able to pivot about cylinder 310 with respect to the bracket 63. The piston 61 can be separated by from the bracket 63 by pulling the pin 302 out of the opening 309, by hand, and then pulling the pin 300, by hand, out from the openings, not shown, of the bracket 63 and the piston 61. The pin 300 can be removed or detached, thereby disconnecting bracket 63 and 61, by hand, without the use of a tool. Although a tool, such as pliers, can be used if necessary.

FIG. 5 shows a perspective front view of an apparatus 400 including a plurality of stairs 402, 404, 406, and 408, and a plurality of stair mat sensors 412, 414, 416, and 418 (also called pressure sensitive mat devices) in accordance with another embodiment of the present invention. The stairs 402, 404, 406, and 408 include top surfaces 402a, 404a, 406a, and 408a, respectively, and side surfaces 402b, 404b, 406b, and 408b, respectively. Each stair mat sensor of 412, 414, 416, and 418 may be any type of mat sensor, pressure sensor, or safety mat sensor, such as a soft tactile transducer sensor (STTS) known in the art, which is used for safety mat sensors.

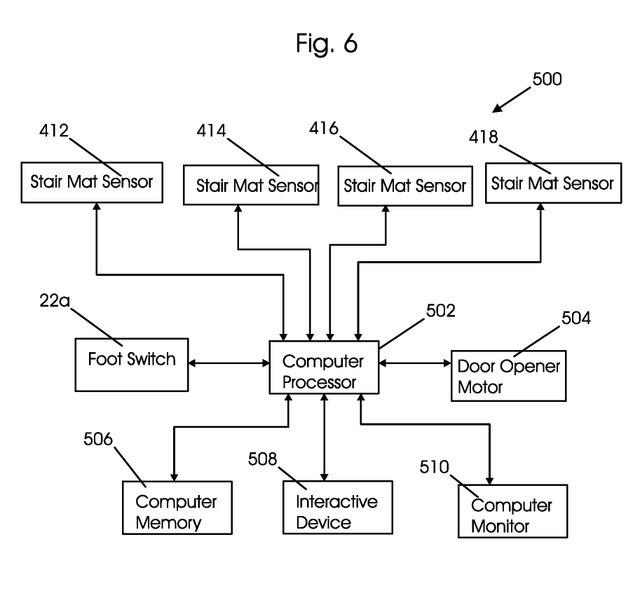

FIG. 6 shows a block diagram of an apparatus 500 including the plurality of stair mat sensors 412, 414, 416, and 418, a computer processor 502, a computer memory 506, an interactive device 508, a computer monitor 510, and a door opener motor 504 in accordance with another embodiment of the present invention. In operation, any of the stair mat sensors 412, 414, 416, and 418 may detect a person stepping on the particular sensor and send a signal to indicate this to the computer processor 502. For example sensor 412 may detect a person stepping on sensor 412, and then send a signal indicating this to the computer processor 502. FIG. 6 also shows that foot switch 22a (shown in FIG. 1) communicates with computer processor 502, so that foot switch 22a can be used to activate the door opener motor 504, through computer processor 502. The door opener motor 504 may be motor 61 shown in FIG. 1 or motor 261 shown in FIG. 3B.

The computer processor 502 in response to the signal from one of the stair mat sensors 412, 414, 416, and 418, such as sensor 412, may be programmed to send a signal to the door opener motor 504 to activate door opener 504 and to cause a basement door to be opened. The door opener motor 504 may be the same as the door opener motor 62 of FIG. 1 or 162 of FIG. 2 and when activated may open a basement door or door leaf, such as basement door leaf 44 or basement door 144, respectively, in a manner previously described.

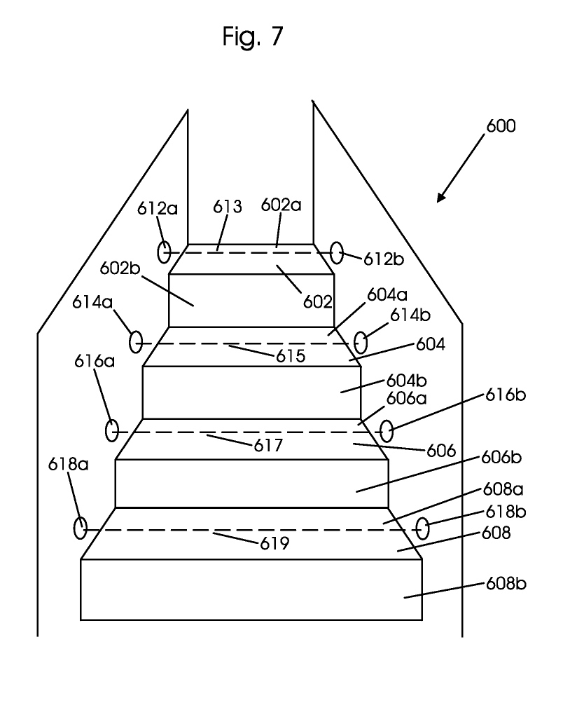

FIG. 7 shows a perspective front view of an apparatus 600 including a plurality of stairs 602, 604, 606, and 608, and a plurality of stair optical devices 612a-b, 614a-b, 616a-b, and 618a-b (also called optical sensor devices), in accordance with another embodiment of the present invention. The stairs 602, 604, 606, and 608 include top surfaces 602a, 604a, 606a, and 608a, respectively, and side surfaces 602b, 604b, 606b, and 608b, respectively. Each optical device of 612a-b, 614a-b, 616a-b, and 618a-b may be any type of optical sensor or devices making up any type of optical sensor.

FIG. 8 shows a block diagram of an apparatus 700 including a plurality of optical sensors 612, 614, 616, and 618, a computer processor 702, a computer memory 706, an interactive device 708, a computer monitor 710, and a door opener motor 704 in accordance with another embodiment of the present invention. The optical sensors 612, 614, 616, and 618 may include optical devices 612a-b, 614a-b, 616a-b, and 618a-b respectively.

In operation, any of the optical sensors 612, 614, 616, and 618 may detect a person stepping in between the respective optical devices 612a-b, 614a-b, 616a-b, and 618a-b and send a signal to indicate this to the computer processor 702. For example sensor 612 may detect a person stepping in between optical devices 612a-b, which may interrupt a light beam 613 which without an obstruction would pass from optical device 612a to optical device 612b. The interruption of the light beam 613 may cause a signal to be sent from either optical device 612a or 612b of optical sensor 612, to the computer processor 702, indicating that a person has stepped on stair 602. The computer processor 702 would then send a signal to and activate door opener motor 704.

Door opener motor 704 may be the same as motor 62 of FIG. 1 or motor 162 of FIG. 2, and may open door leaf 44 or door 144 in response to a signal from computer processor 702. The door leaf 44 and the door 144 may be opened by the motor 62 or 162 in the manner previously described with reference to FIG. 1 and FIG. 2, respectively.

The stair mat sensors 412-418 and the stair optical sensors 612-618 may be thought of as a part of safety reverse devices. For example if the basement door leaf 44 or door 144 is in the process of being closed and someone steps on at least one of the stair mat sensors 412-418 or interferes with at least one of the optical sensors 612-618, then the computer processor 502 or 702 may be programmed to automatically cause the door opener motor 704 to open the door leaf 44 or door 144. The door opener motor 704 may also simply stop the closing process so that the door leaf 44 or door 144 does not move.

The stair mat sensors 412-418 may be triboelectric sensors, such as shown in U.S. Pat. No. 6,367,332, which is incorporated by reference. The stair mat sensors 412-418 may communicate with the computer processor 502 via a communications link, which may be wired or wireless. The optical sensors 612-618 may include Hawk Eye Sensors (Trademarked) which are known in the art. The stair mat sensors 412-418 may be embedded in the stairs 402, 404, 406, and 408, respectively. The stair mat sensors 412-418 may be permanently or semi-permanently attached to the surfaces 402a, 402b, 402c, and 402d, respectively.

Each of the optical sensors 612, 614, 616, 618 may be a photo electronic eye. In one embodiment of the present invention, both the stair mat sensors 412-418 and the optical sensors 612, 614, 616, and 618 may be used. In such an embodiment sensors 412-418 and 612, 614, 616, and 618 all send a signal to a computer processor, such as 502 or 702 when one of the sensors is activated by a person stepping on or interfering with a sensor, as previously discussed. The computer processor 502 or 702 then causes the motor 504 or 704 to be activated causing a basement door to be opened or causing the movement of the basement door to stop.

The door opener motor 704 can also be activated by the foot switch 22a shown in FIG. 1, and shown in block diagram format in communication with computer processor 702 in FIG. 8. The foot switch 22a may be located at or near the front wall 22 and can be used to open or close the door (such as door leaf 44 or door 144) from outside of a building to which the door leaf 44 or door 144 leads. An individual can kick, or step on, a foot switch 22a shown in FIG. 1, and referred to in the block diagram in FIG. 6 and FIG. 8, which may be located near the front wall 22, outside of the base or foundation 11. The foot switch 22a may activate motor 504 or motor 704 through computer processor 502 or 702, shown in FIG. 6 and FIG. 8, respectively. In one embodiment the motor 261, which may also be called a linear actuator, shown in FIG. 3C, may contain a clutch/torque limiter to stop the door leaf 44 shown in FIG. 1, or door 144 shown in FIG. 2, from closing if and when the door leaf 44 or door 144 comes into contact with an obstruction (such as a person walking down the stairs) prior to the person reaching an area under the top wall portion 12 in FIG. 1 or top wall portion 112 in FIG. 2. Note that each of 44 and 144 can be called a door or door leaf.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a basement door leaf opening and closing device;
a first sensor device configured so that it can be mounted in relation to a first stair leading to a basement so that a person stepping on the first stair with their foot will cause activation of the first sensor device; and
wherein activation of the first sensor device causes the basement door leaf opening and closing device to open a basement door leaf.

2. The apparatus of claim 1 further comprising
the first stair.

3. The apparatus of claim 1 wherein
the first sensor device is an optical sensor device.

4. The apparatus of claim 1 wherein
the first sensor device is a pressure sensitive mat device.

5. The apparatus of claim 1 further comprising
a second sensor device configured so that it can be mounted in relation to a second stair leading to the basement so that a person stepping on the second stair with their foot will cause activation of the second sensor device;
wherein activation of the second sensor device causes the basement door leaf opening and closing device to open the basement door leaf.

6. The apparatus of claim 5 wherein
the first stair and the second stair are the same.

7. The apparatus of claim 5 wherein
the first stair and the second stair are different.

8. The apparatus of claim 1 further comprising
a computer processor; and
wherein the first sensor device communicates with the computer processor and activation of the first sensor device sends a signal to the computer processor which causes the computer processor to send a signal to the basement door leaf opening and closing device to open the basement door leaf.

9. A method comprising:
installing a basement door leaf opening and closing device so that the basement door leaf opening and closing device can open and close a basement door leaf leading to a basement;
installing a first sensor device in relation to a first stair leading to the basement so that a person stepping on the first stair with their foot will cause activation of the first sensor device; and
configuring the first sensor device with respect to the basement door leaf opening and closing device so that the activation of the first sensor device causes the basement door leaf opening and closing device to open the basement door leaf.

10. The method of claim 9 wherein
the first sensor device is an optical sensor device.

11. The method of claim 9 wherein
the first sensor device is a pressure sensitive mat device.

12. The method of claim 9 further comprising
installing a second sensor device in relation to a second stair leading to the basement so that a person stepping on the second stair with their foot will cause activation of the second sensor device; and
configuring the second sensor device with respect to the basement door leaf opening and closing device so that the activation of the second sensor device causes the basement door leaf opening and closing device to open the basement door leaf.

13. The method of claim 12 wherein
the first stair and the second stair are the same.

14. The method of claim 12 wherein
the first stair and the second stair are different.

15. The method of claim 9 wherein
configuring the first sensor device with respect to the basement door leaf opening and closing device so that the activation of the first sensor device causes the basement door leaf opening and closing device to open the basement door leaf, includes installing a computer processor; and
wherein the first sensor device communicates with the computer processor and activation of the first sensor device sends a signal to the computer processor which causes the computer processor to send a signal to the basement door leaf opening and closing device to open the basement door leaf.
